(19) United States
(12) Patent Application Publication
(10) Pub. No.: US 2024/0089596 A1
(43) Pub. Date: Mar. 14, 2024

(54) AUTOFOCUSING TECHNIQUES FOR IMAGE SENSORS

(71) Applicant: QUALCOMM Incorporated, San Diego, CA (US)

(72) Inventors: Nikhil VERMA, Bangalore (IN); Shashwat DUBEY, Bangalore (IN); Prakasha NAYAK, Parkasha (IN)

(21) Appl. No.: 17/931,080

(22) Filed: Sep. 9, 2022

(51) Int. Cl. H04N 5/232

(52) U.S. Cl. CPC H04N 5/23212; H04N 9/04553

(57) ABSTRACT

Systems and techniques are described for determining one or more lens positions. For instance a process can include moving a lens to a first lens position, determining a first light focus value for a first image captured at the first lens position, determining a first infrared (IR) focus value for the first image captured at the first lens position, determining whether the first IR focus value exceeds the first light focus value, moving the lens to a second position based on whether the first IR focus value exceeds the first light focus value, determining a second light focus value for a second image captured at the second position, determining a second IR focus value for a second image captured at the second position, and determining a focused lens position based on the second light focus value, the second IR focus value, and a threshold focus value.

### FIELD

The present application is generally related to camera autofocusing. For example, aspects of the application relate to systems and techniques for increasing a speed of autofocusing for cameras capable of capturing infrared (IR) light along with visible light.

### BACKGROUND

Many devices and systems allow a scene to be captured by generating images (or frames) and/or video data (including multiple frames). For example, a camera or a device including a camera (or cameras) can capture a sequence of frames of a scene (e.g., a video of a scene) based on light entering the camera. To enhance a quality of frames captured by the camera, the camera may include lenses to focus light entering the camera. The sequence of frames captured by the camera can be output for display, can be output for processing and/or consumption by other devices, among other uses.

Some devices are configured to capture color images by detecting color (e.g., visible spectrum) light. In some cases, color images can include red, green, and blue (RGB) color components. In some cases, an image capture device may include an infrared (IR) cut filter (e.g., positioned between an image sensor and a lens of the image capture device) to block IR light from being detected by the image sensor

Some devices can be configured to detect both color and IR light, and are referred to as RGB plus IR image capture devices or RGBIR image capture devices herein. For example, an image sensor included in an RGBIR image capture device may detect RGB and IR light components and an image produced by the RGBIR image capture device can include RGB and IR signal values. In some cases, an IR cut filter used in RGB image capture devices can be omitted, which an allow IR light to reach an RGBIR image sensor. In some cases, the photodiodes of an RGBIR image capture device that are configured to detect R, G, and B colors may be sensitive to IR light, and as a result the color signal values produced by the photodiodes of the RGBIR image capture device can be inaccurate. In some examples, an RGB image capture device may also omit an IR cut filter, which can allow IR light to reach an RGB image sensor and may result in inaccurate color in images produced by the RGB image capture device.

### SUMMARY

In some examples, systems and techniques are described for determining one or more lens positions. According to some aspects, the systems and techniques include moving a lens to a first lens position, determining a first visible light focus value for a first image captured at the first lens position, determining a first infrared (IR) focus value for the first image captured at the first lens position, determining whether the first IR focus value exceeds the first visible light focus value, moving the lens to a second position based on whether the first IR focus value exceeds the first visible light focus value, determining a second visible light focus value for a second image captured at the second position, determining a second IR focus value for a second image captured at the second position, determining a focused lens position based on a comparison between the second visible light focus value and the second IR focus value and a threshold focus value, and outputting the focused lens position. In some cases, such systems and techniques may more quickly output a focused lens position as compared to other techniques for determining the lens position.

In another example, an apparatus for determining one or more lens positions. In some examples, the apparatus comprises at least one memory and at least one processor coupled to the at least one memory. In some examples, the at least one processor configured to: move a lens to a first lens position, determine a first visible light focus value for a first image captured at the first lens position, determine a first infrared (IR) focus value for the first image captured at the first lens position, determine whether the first IR focus value exceeds the first visible light focus value, move the lens to a second position based on whether the first IR focus value exceeds the first visible light focus value, determine a second visible light focus value for a second image captured at the second position, determine a second IR focus value for a second image captured at the second position, determine a focused lens position based on a comparison between the second visible light focus value and the second IR focus value and a threshold focus value, and output the focused lens position.

In another example, a non-transitory computer-readable medium having stored thereon instructions. The instructions, when executed by at least one processor, cause the at least one processor to: move a lens to a first lens position, determine a first visible light focus value for a first image captured at the first lens position, determine a first infrared (IR) focus value for the first image captured at the first lens position, determine whether the first IR focus value exceeds the first visible light focus value, move the lens to a second position based on whether the first IR focus value exceeds the first visible light focus value, determine a second visible light focus value for a second image captured at the second position, determine a second IR focus value for a second image captured at the second position, determine a focused lens position based on a comparison between the second visible light focus value and the second IR focus value and a threshold focus value, and output the focused lens position.

In another example, an apparatus for determining one or more lens positions. The apparatus incudes means for moving a lens to a first lens position, means for determining a first visible light focus value for a first image captured at the first lens position, means for determining a first infrared (IR) focus value for the first image captured at the first lens position, means for determining whether the first IR focus value exceeds the first visible light focus value, means for moving the lens to a second position based on whether the first IR focus value exceeds the first visible light focus value, means for determining a second visible light focus value for a second image captured at the second position, means for determining a second IR focus value for a second image captured at the second position, means for determining a focused lens position based on a comparison between the second visible light focus value and the second IR focus value and a threshold focus value, and means for outputting the focused lens position.

In some aspects, one or more of the apparatuses described above is, is part of, or includes a mobile device (e.g., a mobile telephone or so-called “smart phone” or other mobile device), a wearable device, an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, an apparatus includes a camera or multiple cameras for capturing one or more images. In some aspects, the apparatus includes a display for displaying one or more images, notifications, and/or other displayable data. In some aspects, the apparatus can include one or more sensors. In some cases, the one or more sensors can be used for determining a location and/or pose of the apparatus, a state of the apparatuses, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1A is a block diagram illustrating an architecture of an image capture and processing device, in accordance with some examples;

FIG. 1B is a block diagram illustrating an additional architecture of an image capture and processing device in accordance with some examples;

FIG. 2A and FIG. 2B are diagrams illustrating example Red, Green, and Blue (RGB) color filter arrays, in according with some examples;

FIG. 2C and FIG. 2D are diagrams illustrating example RGB plus infrared (RGBIR) filter arrays, in accordance with some examples;

FIG. 3 illustrates light refraction for an example camera, in accordance with aspects of the present disclosure;

FIG. 4 is a graph illustrating an example plot of RGB focus values and lens positions, in accordance with aspects of the present disclosure;

FIG. 5 is a graph illustrating an example plot of RGB and IR focus values and lens positions, in accordance with aspects of the present disclosure;

FIG. 6 is a flow diagram illustrating a search technique for focusing a camera, in accordance with aspects of the present disclosure;

FIG. 7 is a graph illustrating interpolating focused lens positions based on focus value curve slopes, in accordance with aspects of the present disclosure;

FIG. 8 is a flow diagram illustrating an RGB and IR focus interpolation focusing technique for focusing a camera, in accordance with aspects of the present disclosure;

FIG. 9 is a flow diagram illustrating a process for focusing a camera, in accordance with aspects of the present disclosure;

FIG. 10 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

Many image capture devices are configured to capture different portions of the electromagnetic spectrum, such as visible light, infrared (IR), ultraviolet (UV), etc. Devices that capture some or all of the visible spectrum are also be referred to as color image capture devices. Examples of color image capture devices include image capture devices that capture images including a red (R) component, a green (G) component, and a blue (B) component (collectively RGB) per pixel, image capture devices that capture images including luma, chroma-blue, and chroma-red (YUV, YCbCr, Y′CbCr, etc.) components per pixel, etc. For instance, RGB image capture devices utilize color filters to separate incoming light into different color light components. In one example, a Bayer color filter can filter incoming light into RGB light components and RGB photodiodes can capture corresponding RGB light to produce RGB signal values for each pixel in the sensor of the image capture device.

Devices that capture some or all of the IR spectrum can also be referred to as IR image capture devices herein. In some cases, IR image capture devices can include at least a portion of an image sensor that is sensitive to IR light and does not include an IR cut filter filtering IR light from at least the IR sensitive portion of the image sensor. In some cases, an IR cut filter can be implemented as a global element that either completely covers an image sensor or is not present.

Some devices can be configured to capture both color and IR signal information, and are referred to as RGB and IR image capture devices or RGBIR image capture devices herein. For example, an image sensor included in an RGBIR image capture device may detect RGB and IR light components and an image produced by the RGBIR image capture device can include RGB and IR signal components. In some implementations, an RGBIR image capture device may not include an IR cut filter in front of the RGBIR image sensor and as a result produce inaccurate color in some lighting conditions. In some implementations, an RGBIR image capture device may include an RGB image sensor and an RGBIR image sensor with similar or the same resolution. In some examples, the RGB image capture device can include an IR cut filter in front of the RGB image sensor (e.g., between the lens and the image sensor). In some cases, the RGBIR image capture device can switch between the RGB image sensor and RGBIR image sensor depending on lighting conditions and/or split the incoming light (e.g., using a prism) so that appropriate portions of the light spectrum reach each image sensor. In some aspects, the RGBIR image capture device (e.g., a security camera) may include a mechanical arm or other mechanism that moves an IR cut filter away from the image sensor when IR light is present (e.g., under low light conditions when an IR illumination source is used) and moves the IR cut filter in front of the image sensor under well-lit or ambient light conditions. In some cases, an image sensor (e.g., a main image sensor) included in an RGBIR image capture device with a mechanism to move an IR cut filter can be an RGB image sensor (e.g., including R photodiodes, G photodiodes, and B photodiodes). In some cases, because IR light is allowed to reach the RGB image sensor, the resulting color images produced by the RGBIR sensor can be inaccurate.

Systems, apparatuses, methods (also referred to as processes or techniques), and computer-readable media (collectively referred to herein as “systems and techniques”) are described herein for increasing a speed of autofocus operations for image sensors or cameras configured to capture IR and visible light (e.g., RGBIR image sensors or cameras). According to some aspects, the systems and techniques may include a search technique for focusing a camera. For instance, to focus a camera for a scene, a camera control mechanism may move a lens of the camera to certain point (e.g., a middle point) of a current lens position range and determine a normalized RGB focus value and a normalized IR focus value for a current lens position (e.g., at the middle point of the current lens position range). The systems and techniques may compare a difference between the normalized IR focus value and normalized RGB focus value to a threshold percentage of the total range of normalized focus values. For example, if the normalized IR focus value and normalized RGB focus value are close enough (e.g., within the threshold percentage), a fine focus (e.g., autofocus) search may be performed to precisely focus the camera.

In some cases, if the normalized IR focus value and normalized RGB focus value are not within the threshold percentage, additional operations may be performed. For example, if the normalized IR focus value is greater than the normalized RGB focus value, the systems and techniques may determine that a peak of an IR focus value curve has not yet been reached and may set a lens position range to the right of the current lens position as the current lens position range for performing the search technique noted above. In another example, if the normalized IR focus value is less than the normalized RGB focus value, the systems and techniques may determine that the peak of the IR focus value curve has been exceeded and may set a lens position range to the left of the current lens position as the current lens position range. Once the current lens position range is adjusted, the lens may again be moved to a point (e.g., a middle point) of the current lens position range (establishing a new current lens position), another image may be captured, and another normalized RGB focus value and normalized IR focus value may be determined for the current lens position.

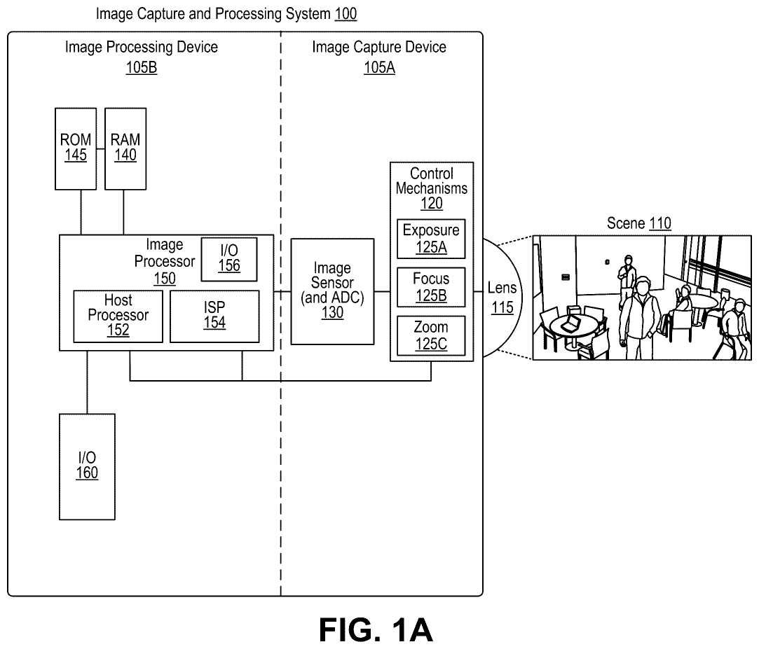

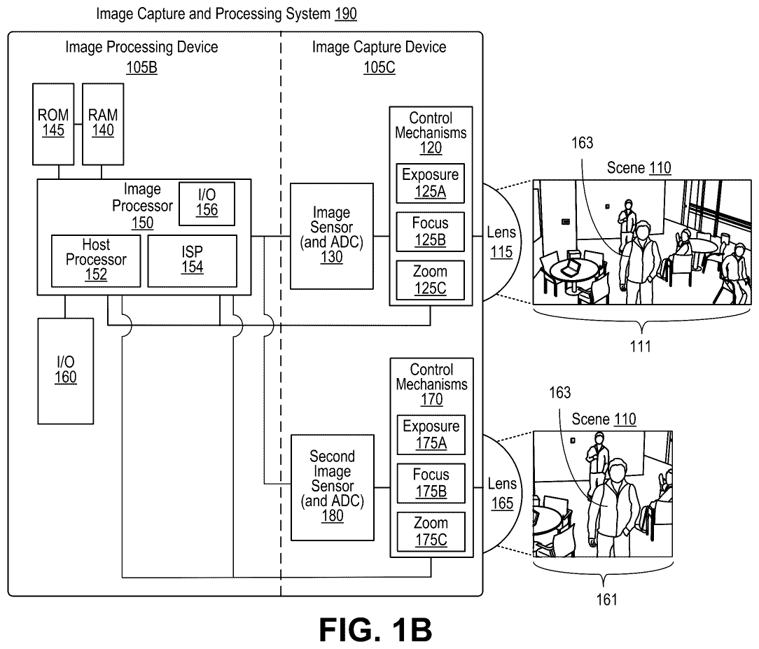

Various aspects of the techniques described herein will be discussed below with respect to the figures. FIG. 1A is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the image capture and processing system 100 faces a scene 110 and receives light from the scene 110. In some cases, the lens 115 and image sensor 130 can be associated with an optical axis. In one illustrative example, the photosensitive area of the image sensor 130 (e.g., the photodiodes) and the lens 115 can both be centered on the optical axis. The lens 115 bends incoming light from the scene 110 toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom setting by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

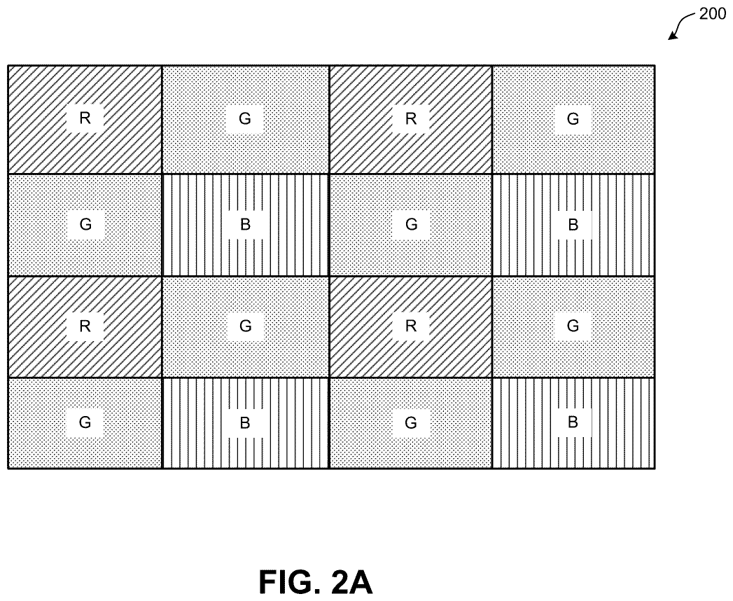

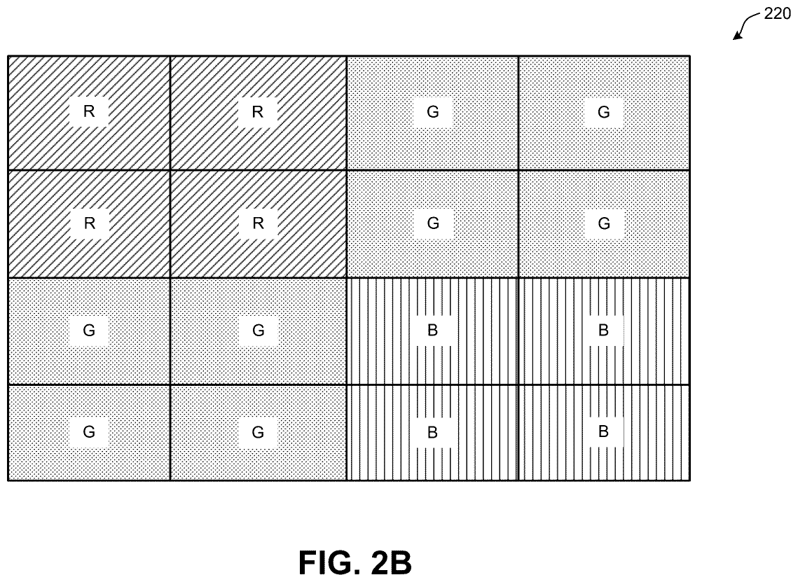

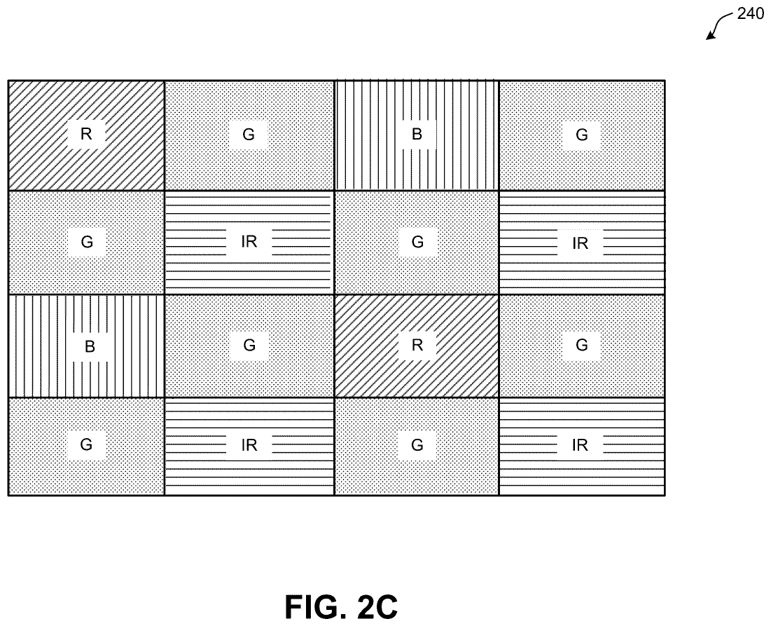

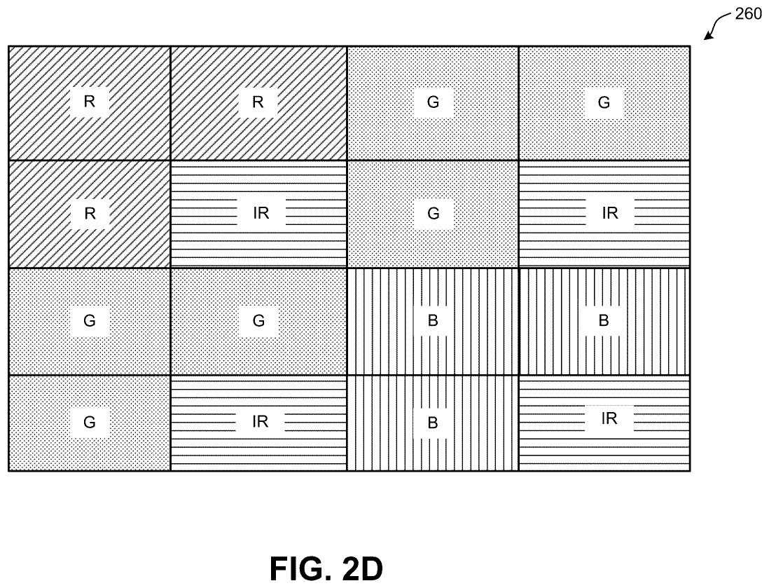

An example of a Bayer color filter array 200 is shown in FIG. 2A. As illustrated in FIG. 2A, the Bayer color filter array 200 includes a repeating pattern of R color filters, B color filters, and G color filters. FIG. 2B illustrates an example quad color filter array (QCFA) 220. As shown, QCFA 220 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the Bayer color filter array 200 shown in FIG. 2A, the pattern of the QCFA 220 shown in FIG. 2B, any other color filter, or any combination thereof can be repeated for the entire array of photodiodes of a given image sensor 130.

Returning to FIG. 1A, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., RGB or other color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked).

FIG. 2C illustrates an example RGBIR filter 240 that incorporates IR photodiodes in addition to the R, G, B colors shown in the Bayer color filter array 200 of FIG. 2A and QCFA 220 of FIG. 2B. Similarly, FIG. 2D illustrates another example RGBIR filter 260 Similar to the QCFA 220 of FIG. 2B, replacing one photodiode of each RGB quad of the QCFA 220 to operate as an IR photodiode. In some cases, in addition or as an alternative to the use of filters, different photodiodes throughout the pixel array can have different spectral sensitivity curves, therefore responding to different wavelengths of light. Monochrome image sensors may lack filters and therefore lack color depth.

Returning to FIG. 1A, In some cases, the image sensor 130 may alternately or additionally include opaque and/or reflective masks that block light from reaching certain photodiodes, or portions of certain photodiodes, at certain times and/or from certain angles. In some cases, the opaque and/or reflective masks may be used for phase detection autofocus (PDAF). In some cases, opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output by the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

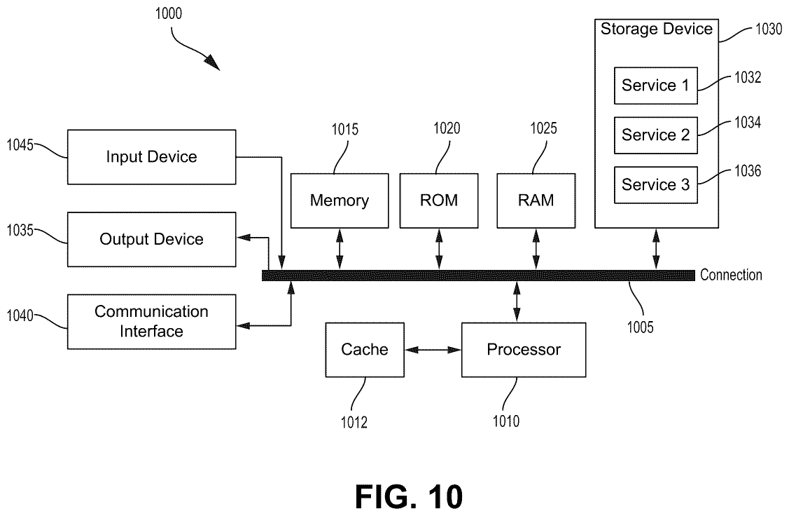

The image processor 150 may include one or more processors, such as one or more image signal processors (ISPs) (including ISP 154), one or more host processors (including host processor 152), and/or one or more of any other type of processor 1010 discussed with respect to the computing system 1000 of FIG. 10. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1035, any other input devices 1045, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1A, a vertical dashed line divides the image capture and processing system 100 of FIG. 1A into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A. Second image sensor

FIG. 1B illustrates another example of an image capture and processing system 190 including the image processing device 105B of FIG. 1B and an image capture device 105C. In the illustrated example, image capture device 105C includes image sensor 130 and control mechanisms 120 described above with respect to FIG. 1A, as well as a second image sensor 180 and control mechanisms 170. The control mechanisms 170 can be similar to and perform similar functions to control mechanisms 120 of FIG. 1A. Exposure control mechanism 175A can be similar to and perform similar functions to exposure control mechanism 125A of FIG. 1A. Focus control mechanism 175B can be similar to and perform similar functions to focus control mechanism 125B of FIG. 1A. Zoom control mechanism 175C can be similar to and perform similar functions to zoom control mechanism 125C.

In some cases, the first image sensor 130 and second image sensor 180 and corresponding lenses 115, 165 of image capture device 105C can have an at least a partially overlapping field of view. As noted above, image sensor 130 and lens 115 can be associated with an optical axis, also referred to as the first optical axis herein. In some examples, the lens 165 and second image sensor can be associated with a second optical axis. In one illustrative example, a photosensitive area of the second image sensor 180 (e.g., the photodiodes) and the lens 165 can be centered on the second optical axis. Other alignments between the image sensor 130 and lens 115 and the second image sensor 180 and lens 165 can be used without departing from the scope of the present disclosure. In some cases, the first optical axis and second optical axis can be physically close together (e.g., multiple cameras of an electronic device). In the illustrated example, the lens 165 can be a different type of lens than lens 115. For example, as illustrated in FIG. 1B, the lens 115 can have a wide field of view 111 (e.g., from a wide-angle lens). In some cases, the lens 165 can have a narrower field of view 161 (e.g., from a telephoto lens) with a higher magnification or zoom factor (as illustrated by the relatively larger size of person 163) than the lens 115. In some cases, one of the image sensor 130 and the second image sensor 180 can be an RGB image sensor and the other of the image sensor 130 and the second image sensor 180 can be an RGBIR sensor. In some cases, color information in an image captured by the RGB image sensor can be used to correct color in an image captured by the RGBIR image sensor.

The image capture and processing systems 100 and/or 190 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing systems 100 and/or 190 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A and/or image capture device 105C can include a camera device and the image processing device 105B can include a computing device, such as a mobile handset, a desktop computer, or other computing device.

While the image capture and processing system 100 and image capture and processing system 190 are shown to include certain components, one of ordinary skill will appreciate that the image capture and processing system 100 and/or image capture and processing system 190 can include more components than those shown in FIG. 1A and FIG. 1B. The components of the image capture and processing systems 100 and/or image capture and processing system 190 can include software, hardware, or one or more combinations of software and hardware. For example, in some implementations, the components of the image capture and processing system 100 and/or image capture and processing system 190 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100 and/or image capture and processing system 190.

Autofocusing may be performed in an image device by a variety of types of actuators. Cameras can focus scenes onto image sensors with lenses that move within a movable range to enable focusing. Autofocus imaging devices move the lens using voice coil motors (VCM), piezo, MEMS, or other solutions. The autofocusing may be controlled by the focus control mechanism 125B.

A variety of autofocus (“AF”) processes may be used in digital imaging devices to determine the direction and how far the mechanical movement will move the lens. Examples of such processes include contrast detection autofocus, phase detection autofocus, and laser assisted autofocus. Contrast detection autofocus may operate by sweeping the lens through multiple positions to detect a position that has a highest contrast. In some cases, it can take approximately 16+frames to focus a camera after launching the camera (e.g., beginning use of the camera) using contrast detection autofocus in good lighting, although this can increase to over 30 frames in low light scenes.

Phase detection autofocus may operate using special hardware, such as phase detection pixels or mirror arrangements which can split light into multiple beams and detect a convergence of the beams to indicate that part of the scene is focused. In addition to the hardware requirements, phase detection autofocus may use more processing power to control and focus the camera, as compared to contrast detection. Phase detection autofocus can enhance a speed of focusing as phase detection autofocus can focus the camera in about 4 frames after launching the camera.

Laser assisted autofocus may operate by using a laser or other time of flight sensor to measure a distance to an object being focused on and focus the lens based on the measurement. In some cases, laser assisted autofocus may be used in conjunction with contrast detection autofocus, for example, to help accelerate the lens sweeping by skipping certain lens settings, or providing a rough estimate of the focus. As indicated above, both laser assisted autofocus and phase detection autofocus processes may use dedicated hardware resources, which can increase camera costs as compared to contrast detection autofocus. Techniques to accelerate contrast detection autofocus thus could help reduce camera costs as compared to laser assisted or phase detection autofocus techniques.

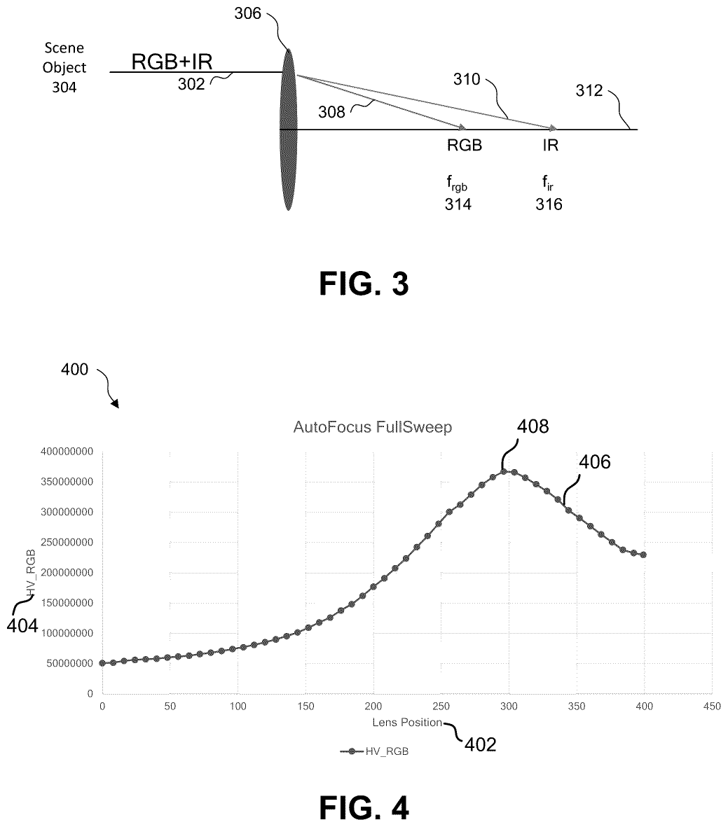

FIG. 3 illustrates light refraction for an example camera, in accordance with aspects of the present disclosure. In FIG. 3, visible and IR light beams, labeled as RGB+IR 302, from a scene object 304 enter a point on a lens 306. The lens 306 refracts the visible light beam (e.g., RGB light beam 308) and IR light beam 310 such that the beams are focused on a point on a plane 312. When the camera is focused, an image sensor (not shown) should be at the point where the RGB light beam 308 and IR light beam 310 cross plane 312. However, as different wavelengths of light may refract differently for a given lens, such as lens 306, the RGB light beam 308 and IR light beam 310 may focus at different points. In some cases, the RGB light beam 308 may cross plane 312 and focus at a shorter distance from the lens 306 as compared to the IR light beam 310. In some cases, it may not be possible to focus both the RGB image from RGB light and IR image from IR light at the same time.

In some cases, a distance from the lens 306 to where the RGB light beam 308 crosses plane 312 (e.g., focuses) may be a focal length of the RGB light (f_{rgb}) 314. Similarly, a distance from the lens 306 to where the IR light beam 310 crosses plane 312 (e.g., focuses) may be a focal length of the IR light (fᵢᵣ) 316. Focal length can be determined based on equation 1 below:

1/f=(1/u)+(1/v), Equation 1

where f is a focal length, u is a distance from a lens (e.g., lens 306) to an object (e.g., scene object 304), and v is a distance from the lens (e.g., lens 306) to an image (e.g., image sensor). Based on this equation, for a focused RGB image, the corresponding lens position for focusing an IR image can be calculated via equation 2 below:

1/v_{IR}=1/f_{IR}−1/f_{RGB}+1/v_{RGB}. Equation 2

FIG. 4 is a graph 400 illustrating an example plot of RGB focus values and lens positions, in accordance with aspects of the present disclosure. As an example, a focus control mechanism of a camera, such as focus control mechanisms 125B, may be able to move a lens through a moveable range, here 0-400, of a number of steps. Each step may be a possible lens position and the possible lens positions 402 are shown on the X-axis. Focus values 404 are shown on the Y-axis. Focus values 404 may be determined, for example, by the image capture device 105A and may be based on a contrast of a captured frame. In some cases, focus values 404 may be obtained by high pass filtering the luma values over a focus window in the captured frame. Each dot on focus value curve 406 may represent a focus value for a scene corresponding to a particular lens position and graph 400 may be generated by sweeping the lens through a full range of possible lens positions. A frame having a peak focus value 408 may be optimally focused. In some cases, the focus values of the focus value curve 406 may be normalized via any normalization technique, such as through windowed averaging, coring function, tuning parameters (e.g., filter coefficients, autofocus stats tuning) etc., for example, to smooth noisy focus value to lens position plots.

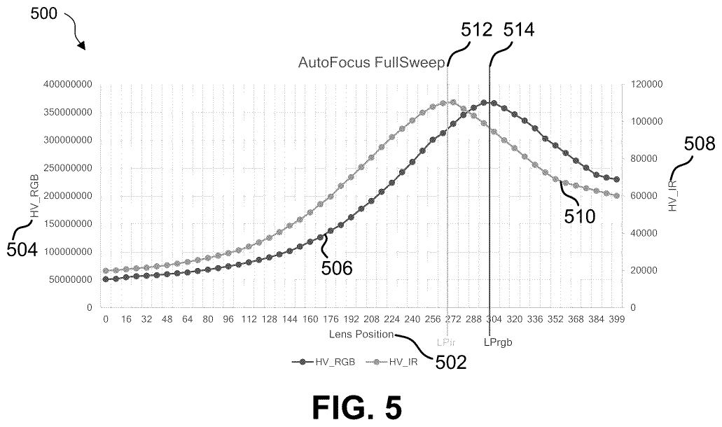

FIG. 5 is a graph 500 illustrating an example plot of RGB and IR focus values and lens positions, in accordance with aspects of the present disclosure. In graph 500, RGB focus values 504 are again shown on the Y-axis and possible lens positions 502 shown on the X-axis. In graph 500, RGB focus value curve 506, which may correspond to focus value curve 406, may be generated based on RGB focus values for a scene for lens positions 502. IR focus values 508 may also be plotted on the Y-axis against possible lens positions 502 as IR focus value curve 510. Each dot on the IR focus value curve 510 may represent IR focus value for a scene corresponding to a particular lens position.

In some cases, the IR focus values 508 may be normalized, for example, using a coring function and tuning parameters based on a peak 512 of the IR focus value curve 510 for certain environmental conditions (e.g., lux, color temperature/correlated color temperature, lumen, etc.). In some cases, the normalization may rescale the IR focus values curve 510 and/or RGB focus value curve 506 to align the peak 512 of the IR focus value curve 510 to a peak 514 of the RGB focus value curve 506 to allow a comparison between the IR focus values of the IR focus value curve 510 and the RGB focus values of the RGB focus value curve 506 despite disparate RGB focus values and IR focus values. Thus, a normalized IR focus value on the IR focus values curve 510 at a given lens position may be comparable to a normalized RGB focus value on RGB focus value curve 506 at the given lens position and the normalized RGB focus value curve 506 and the normalized IR focus value curve 510 have been normalized to a same range of focus values. In some cases, the normalization may be predetermined (foe example during manufacturing or a calibration process) based on expected RGB and IR focus values and the RGB and IR focus values may be normalized without a full sweep of the autofocus range or generating a full RGB or IR focus value curve. In some cases, after normalization, the normalized IR focus value on the IR focus value curve 510 may be correlated with the normalized RGB focus value on the RGB focus value curve 506 based on Equation 2, above.

As indicated in graph 500, the normalized IR focus values and normalized RGB focus values are correlated. For example, the normalized IR focus values of the IR focus value curve 510 for a given lens position exceeds the normalized RGB focus values of the RGB focus value curve 506 for every possible lens position 502 from a first lens position (e.g., lens position 0) until a lens position corresponding to the peak 512 of the IR focus value curve 510. Similarly, the normalized RGB focus values of the RGB focus value curve 506 exceeds the normalized IR focus values of the IR focus value curve 510 for every possible lens position 502 from the lens position corresponding to the peak 514 of the RGB focus value curve 506 until the last lens position (e.g., lens position 399). In the region between peak 512 and peak 514, the IR focus value curve 510 and the RGB focus value curve 506 cross. In some cases, a size of the region between peak 512 and peak 514 may be tunable as a percentage of a range of the normalized focus values (e.g., for the range the IR focus values and RGB focus values are normalized to) using a tunable parameter that may be varied based on environmental conditions (e.g., lux, color temperature/correlated color temperature, lumen, etc.). As an example, the region between peak 512 and peak 514 may be tuned to be 5% of a range of the normalized focus values in good lighting, but 10% of the range of the normalized focus values in low light conditions. In some cases, focusing the camera can make use of the peak correlation between the normalized RGB focus values and normalized IR focus values.

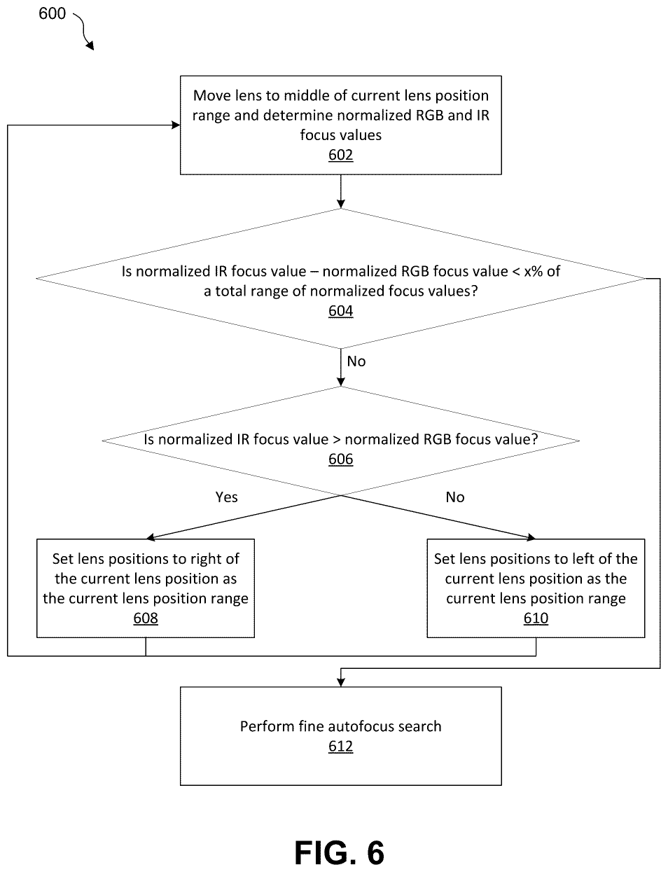

FIG. 6 is a flow diagram illustrating a search technique 600 for focusing a camera, in accordance with aspects of the present disclosure. The search technique 600 may be an iterative technique used to determine a focused lens position. To focus a camera for a scene, a camera control mechanism, such as focus control mechanism 125B of FIG. 1A, may move a lens of the camera to a middle of a current lens position range and determine a normalized RGB focus value and a normalized IR focus value for a current lens position (e.g., at the middle of the current lens position range) at operation 602. For example, with reference to FIG. 5, the camera control mechanism may be instructed or commanded to move the lens to lens position 199 (e.g., a middle of a total lens position range of 0-399) and determine a normalized RGB focus value and a normalized IR focus value for lens position 199. The camera may capture an image at lens position 199 as a part of determining the normalized RGB and IR focus values. In some aspects, the camera control mechanism may move the lens to the middle of the current lens position range based on a binary search pattern, where a target lens position is selected based on a middle of the current lens position range. In other cases, any other search patterns based on any other search algorithm may be used to select the lens position.

At operation 604, a difference between the normalized IR focus value and normalized RGB focus value is compared to a threshold percentage (e.g., x %) of the total range of normalized focus values. In some cases, the threshold percentage (e.g., x %) may be tunable based on environmental conditions (e.g., lux, color temperature/correlated color temperature, lumen, distance to object, etc.). If the normalized IR focus value and normalized RGB focus value are close enough (e.g., within the threshold percentage), execution may proceed to operation 612 where fine focus (e.g., autofocus) search may be performed to precisely focus the camera. The fine focus search may be performed using any existing fine focusing search technique. In some cases, the threshold percentage may be tuned to correlate with peaks (e.g., peaks 514 and 512) of the normalized RGB focus values and normalized IR focus values. If the normalized IR focus value and normalized RGB focus value are not within the threshold percentage, execution proceeds to operation 606.

At operation 606, if the normalized IR focus value is greater than the normalized RGB focus value, execution proceeds to operation 608. For example, with reference to FIG. 5, at current lens position 199, the normalize IR focus value is greater than the normalized RGB focus value. In such a case, it may be inferred that the peak 512 of the IR focus value curve 510 has not yet been reached, indicating that the lens may be moved to in a direction to the right, and a lens position range to the right of the current lens position (e.g., lens position 199) may be set as the current lens position range (e.g., lens positions 200-400). Execution may then return to operation 602 for a next iteration (e.g., loop, repetition, etc.). In this loop at operation 602, the lens may again be moved to the middle of the current lens position range, another image captured, and another normalized RGB focus value and normalized IR focus value for a current lens position. Continuing the current example, the lens may be moved to lens position 300 and normalized RGB and IR focus values determined for lens position 300. For the current example, it can be assumed that the difference between the normalized IR focus value and normalized RGB is less than the threshold and execution can proceed to operation 606.

At operation 606, if the normalized IR focus value is less than the normalized RGB focus value, execution proceeds to operation 610. In the current example, at lens position 300, the normalized IR focus value is less than the normalized RGB focus value and it may be inferred that the peak 512 of the IR focus value curve 510 has been passed. Where the normalized IR focus value is less than the normalized RGB focus value, the lens position range to the left of the current lens position (e.g., from lens positions 200-300) may be set as the current lens position range. Execution may then return to operation 602. As shown in operations 606-610, a comparison between the normalized IR focus values and normalized RGB focus values indicates a direction the lens should move. Of note, in ordinary contrast detection autofocus, no directional indication for the lens is provided based on focus values from a single lens position (see FIG. 4). The directional indication provided using search technique 600 does not rely on a use of phase detection pixels. In one illustrate example, it may take approximately 6 frames to achieve a coarse focus and another 2 frames for fine focusing. Search technique 600 may be used to find a focus for either IR or RGB images, for example, by performing the fine focus search based on either IR or RGB. In some cases, if a lens position is found for focusing in RGB (or IR), a lens position for focusing in IR (or RGB) can be determined using Equation 2, above.

As indicated above, RGB focus values and IR focus values may be normalized so the peak of the RGB focus value curve and the peak of the IR focus value curve are aligned. When normalized, the RGB focus values curve and the IR focus values curve may have a uniform slope difference. Once slopes are determined, focused lens positions for RGB and IR frames can be interpolated based on the slopes.

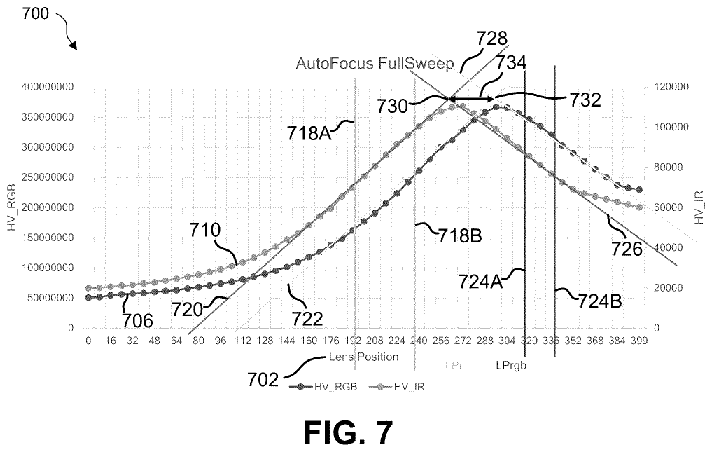

FIG. 7 is a graph 700 illustrating interpolating focused lens positions based on focus value curve slopes, in accordance with aspects of the present disclosure. As with graph 500, possible lens positions 702 shown on the X-axis, a normalized RGB focus value curve 706 shows RGB focus values for possible lens positions 702, and a normalized IR focus value curve 710 shows IR focus values for possible lens positions 702. The normalized RGB focus value curve 706 and the normalized IR focus value curve 710 have been normalized to a same range of focus values in graph 700.

In some cases, a normalized RGB focus value and a normalized IR focus value can be obtained from two lens positions 718A, 718B before a peak of the IR focus value curve and a peak of the RGB focus value curve (e.g. where the IR focus value is greater than the RGB focus value). Based on the normalized RGB focus values and the normalized IR focus values obtained from lens positions 718A and 718B, a pre-peak slope 720 can be determined for the IR focus curve 710 and a pre-peak slope 722 can be determined for the RGB focus curve 706. The pre-peak slope 720 interpolates pre-peak IR focus values for pre-peak lens positions, and the pre-peak slope 722 interpolates pre-peak RGB focus values for pre-peak lens positions.

Similarly, a normalized RGB focus value and a normalized IR focus value can be obtained from two lens positions 724A, 724B after the peak of the IR focus value curve and the peak of the RGB focus value curve (e.g. where the IR focus value is less than the RGB focus value). Based on the normalized RGB focus values and the normalized IR focus values obtained from lens positions 724A and 724B, a post-peak slope 726 can be determined for the IR focus curve 710 and a post-peak slope 728 can be determined for the RGB focus curve 706. The post-peak slope 726 interpolates post-peak IR focus values for post-peak lens positions, and the post-peak slope 726 interpolates post-peak RGB focus values for post-peak lens positions.

In some cases, the IR focus value curve 710 pre-peak slope 720 intersects 730 the post-peak slope 726 at approximately the peak of the IR focus value curve 710. Similarly, the RGB focus value curve 706 pre-peak slope 722 intersects 732 the post-peak slope 728 at approximately the peak of the RGB focus value curve 706. In some cases, a fine focus search can be performed based on a lens position range 734 between the approximate peak (e.g., intersection 730) of the IR focus value curve 710 and the approximate peak (e.g., intersection 732) of the RGB focus value curve 706. This fine focus search may be performed, for example, by selecting a point in lens position range 734 and performing any existing fine focusing search technique based on the selected point. In some cases, Equation 2 can be used as a check to confirm that the approximate peak (e.g., intersection 730) of the IR focus value curve 710 and the approximate peak (e.g., intersection 732) of the RGB focus value curve 706 satisfy Equation 2 within a threshold deviation amount.

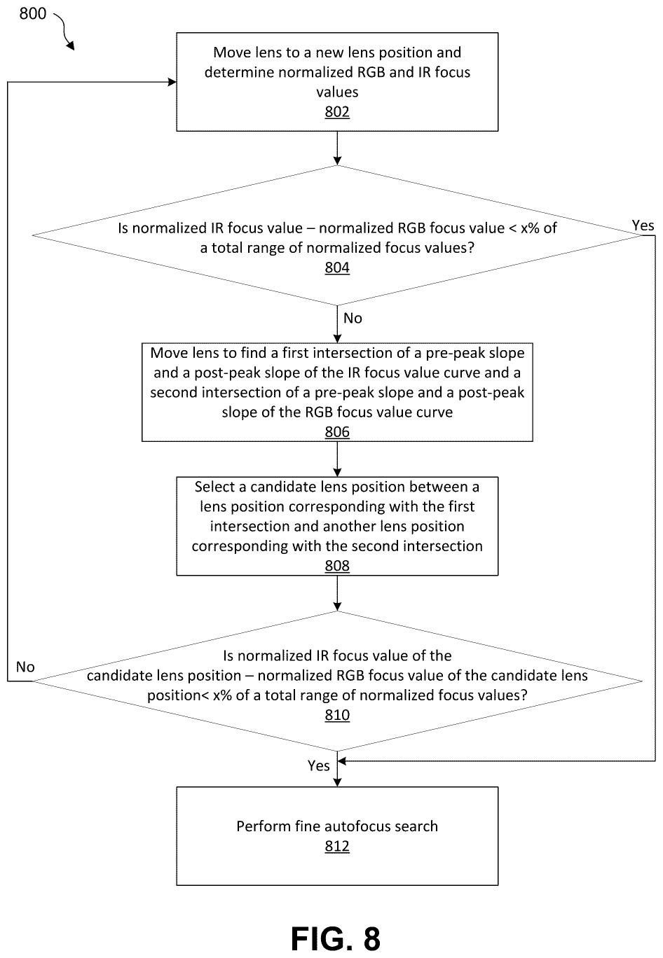

FIG. 8 is a flow diagram illustrating an RGB and IR focus interpolation focusing process 800 for focusing a camera, in accordance with aspects of the present disclosure. At operation 802, a lens of a camera may be moved to a new lens position and a normalized RGB focus value and a normalized IR focus value may be determined for the new lens position. In some cases, a random lens position may be selected as the new lens position. In other cases, a predefined new lens position may be used or a lens position may be selected out a range of lens positions predefined based on environmental conditions (e.g., lux, color temperature, lumen, etc.). A normalized RGB focus value and a normalized IR focus value may be determined for the new lens position.

At operation 804, a difference between the normalized IR focus value and normalized RGB focus value is compared to a threshold percentage (e.g., x %) of the total range of normalized focus values. In some cases, the threshold percentage (e.g., x %) may be tunable based on environmental conditions (e.g., lux, color temperature/correlated color temperature, lumen, distance to object, etc.). If the normalized IR focus value and normalized RGB focus value are close enough (e.g., within the threshold percentage), execution may proceed to operation 812 where fine focus (e.g., autofocus) search may be performed to precisely focus the camera. The fine focus search may be performed using any existing fine focusing search technique. If the normalized IR focus value and normalized RGB focus value are not close enough (e.g., outside of the threshold percentage), execution may proceed to operation 806. At operation 806, the lens may be moved to find a first intersection of a pre-peak slope of the IR focus value curve and a post peak slope of the IR focus value curve and to find a second intersection of a pre-peak slope of the RGB focus value curve and a post-peak slope of the RGB focus value curve, as described above in conjunction with FIG. 7. At operation 808, a candidate lens position between a first lens position corresponding with the first intersection and a second lens position corresponding with the second intersection is selected. In some cases, a middle lens position between the first lens position and the second lens position may be selected as the candidate lens position.

A normalized IR focus value and normalized RGB focus value for the candidate lens position are determined based on a captured image at the candidate lens position and at operation 810, if a difference between the normalized IR focus value and normalized RGB focus value at the candidate lens position is less than the threshold percentage (e.g., x %) of the total range of normalized focus values, then execution proceeds to operation 812 where fine focus (e.g., autofocus) search may be performed to precisely focus the camera. If the difference between the normalized IR focus value and normalized RGB focus value at the candidate lens position is greater than a threshold percentage, then execution returns to operation 802 where the lens is moved to a new lens position and process 800 is repeated based on the new lens position. In some cases, a coarse focus may be achieved in as few as four frames based on process 800.

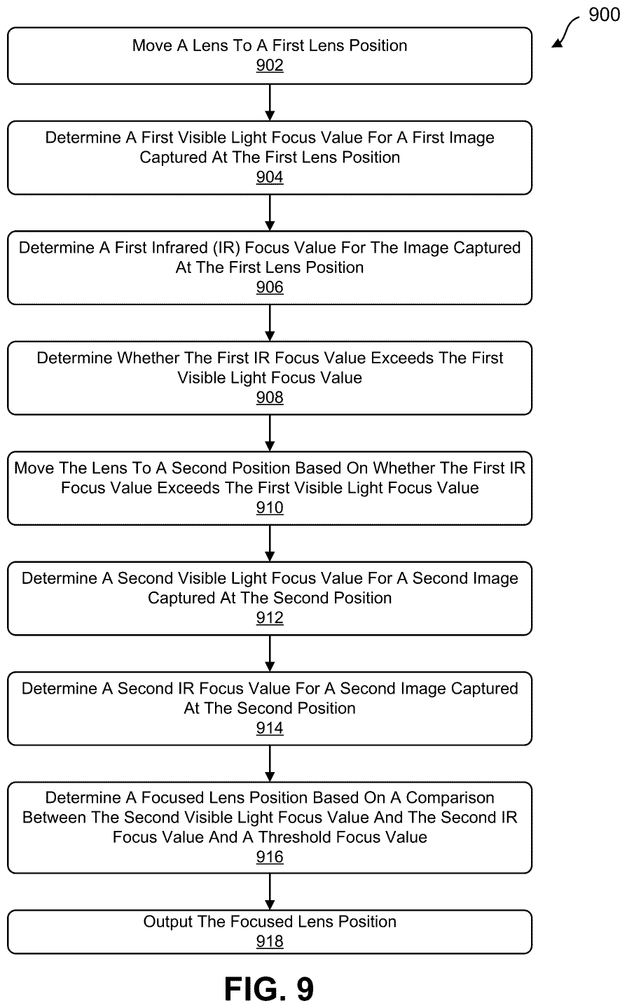

FIG. 9 is a flow diagram illustrating a process 900 for determining one or more lens positions, in accordance with aspects of the present disclosure. The process 900 may be performed by a computing device (or apparatus) or a component (e.g., a chipset, codec, etc.) of the computing device. The computing device may be a mobile device (e.g., a mobile phone), a network-connected wearable such as a watch, an XR device, a vehicle or component or system of a vehicle, or other type of computing device. In some cases, the computing device may be or may include coding device, such as the encoding device 104, the decoding device 112, or a combined encoding device (or codec). The operations of the process 900 may be implemented as software components that are executed and run on one or more processors.

At block 902, the computing device (or component thereof) may move a lens to a first lens position. In some cases, the first lens position is in a middle of a range of lens positions. In some cases, the computing device (or component thereof) may move the lens based on one or more IR focus values and one or more visible light focus values using a binary search pattern or other suitable search pattern.

At block 904, the computing device (or component thereof) may determine a first visible light focus value for a first image captured at the first lens position. At block 906, the computing device (or component thereof) may determine a first infrared (IR) focus value for the first image captured at the first lens position.

At block 908, the computing device (or component thereof) may determine whether the first IR focus value exceeds the first visible light focus value. In some cases, the first visible light focus value, second visible light focus value, first IR focus value, and second IR focus value are normalized to a same range of normalized focus values.

At block 910, the computing device (or component thereof) may move the lens to a second position based on whether the first IR focus value exceeds the first visible light focus value. In some cases, the computing device (or component thereof) may determine a direction to move the lens based on whether the first IR focus value exceeds the first visible light focus value. In some cases, the second position is based on the determined direction to move the lens.

At block 912, the computing device (or component thereof) may determine a second visible light focus value for a second image captured at the second position. At block 914, the computing device (or component thereof) may determine a second IR focus value for a second image captured at the second position.

At block 916, the computing device (or component thereof) may determine a focused lens position based on a comparison between the second visible light focus value and the second IR focus value and a threshold focus value. In some cases, the computing device (or component thereof) may compare the second visible light focus value, the second IR focus value, and the threshold focus value by determining a difference between the second IR focus value and the second visible light focus value; and comparing the difference to the threshold focus value. In some cases, the computing device (or component thereof) may determine the focused lens position by iteratively moving the lens to a third position based on whether the second IR focus value exceeds the second visible light focus value, determining the second visible light focus value for an additional image captured at the third position, determining the second IR focus value for the additional image captured at the third position, determining the difference between the second IR focus value and the second visible light focus value, and stop repeating when the difference between the second IR focus value and the second visible light focus value is within the threshold focus value. In some cases, the threshold focus value comprises a percentage of a range of normalized focus values.

In some cases, the computing device (or component thereof) may also determine that the first IR focus value exceeds the first visible light focus value, determine a visible light pre-peak slope based on the first visible light focus value, determine a IR pre-peak slope based on the first IR focus value, determine that the second visible light focus value exceeds the second IR focus value, determine a visible light post-peak slope based on the second visible light focus value, and determine a IR post-peak slope based on the second IR focus value.

In some cases, the computing device (or component thereof) may also move the lens to a third lens position, determine a third visible light focus value at the third lens position, determine a third IR focus value at the third lens position, determine that the third IR focus value exceeds the third visible light focus value, wherein the IR pre-peak slope is determined based on the first IR focus value and the third IR focus value; and wherein the visible light pre-peak slope is determined based on the first IR focus value and the third IR focus value, move the lens to a fourth lens position, determine a fourth visible light focus value at the fourth lens position, determine a fourth IR focus value at the fourth lens position, and determine that the fourth visible light focus value exceeds the fourth IR focus value, wherein the IR post-peak slope is determined based on the second IR focus value and the fourth IR focus value; and wherein the visible light post-peak slope is determined based on the second IR focus value and the fourth IR focus value.

In some cases, the computing device (or component thereof) may also determine a lens position range based on an intersection of the IR pre-peak slope and IR post peak slope and an intersection of the visible light pre-peak slope and visible light post-peak slope, and estimate the focused lens position based on the determined lens position range, wherein the focused lens position is further determined based on the estimated focus lens position.

At block 918, the computing device (or component thereof) may output the focused lens position. In some cases, the computing device (or component thereof) may perform a fine focus search based on the output focused lens position.

In some examples, the techniques or processes described herein may be performed by a computing device or an apparatus, such as the image capture and processing system 100 and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1000 includes at least one processing unit (CPU or processor) 1010 and connection 1005 that couples various system components including system memory 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: An apparatus for determining one or more lens positions, comprising: at least one memory; and at least one processor coupled to the at least one memory, the at least one processor configured to: move a lens to a first lens position; determine a first visible light focus value for a first image captured at the first lens position; determine a first infrared (IR) focus value for the first image captured at the first lens position; determine whether the first IR focus value exceeds the first visible light focus value; move the lens to a second position based on whether the first IR focus value exceeds the first visible light focus value; determine a second visible light focus value for a second image captured at the second position; determine a second IR focus value for a second image captured at the second position; determine a focused lens position based on a comparison between the second visible light focus value and the second IR focus value and a threshold focus value; and output the focused lens position.

Aspect 2: The apparatus of claim 1, wherein the first visible light focus value, the second visible light focus value, the first IR focus value, and the second IR focus value are normalized to a same range of normalized focus values.

Aspect 3: The apparatus of claim 1, wherein, to compare the second visible light focus value, the second IR focus value, and the threshold focus value, the at least one processor is further configured to: determine a difference between the second IR focus value and the second visible light focus value; and compare the difference to the threshold focus value.

Aspect 4: The apparatus of claim 3, wherein, to determine the focused lens position, the at least one processor is configured to, based on a determination that the difference exceeds the threshold focus value, iteratively: move the lens to a third position based on whether the second IR focus value exceeds the second visible light focus value; determine the second visible light focus value for an additional image captured at the third position; determine the second IR focus value for the additional image captured at the third position; determine the difference between the second IR focus value and the second visible light focus value; and stop repeating when the difference between the second IR focus value and the second visible light focus value is within the threshold focus value.

Aspect 5: The apparatus of claim 1, wherein the at least one processor is configured to move the lens based on one or more IR focus values and one or more visible light focus values using a binary search pattern.

Aspect 6: The apparatus of claim 1, wherein the first lens position is in a middle of a range of lens positions.

Aspect 7: The apparatus of claim 1, wherein the at least one processor is configured to determine a direction to move the lens based on whether the first IR focus value exceeds the second visible light focus value.

Aspect 8: The apparatus of claim 7, wherein the second position is based on the determined direction to move the lens.

Aspect 9: The apparatus of claim 1, wherein the at least one processor is further configured to: determine that the first IR focus value exceeds the first visible light focus value; determine a visible light pre-peak slope based on the first visible light focus value; determine a IR pre-peak slope based on the first IR focus value; determine that the second visible light focus value exceeds the second IR focus value; determine a visible light post-peak slope based on the second visible light focus value; and determine a IR post-peak slope based on the second IR focus value.

Aspect 10: The apparatus of claim 9, wherein the at least one processor is further configured to: move the lens to a third lens position; determine a third visible light focus value at the third lens position; determine a third IR focus value at the third lens position; determine that the third IR focus value exceeds the third visible light focus value, wherein the IR pre-peak slope is determined based on the first IR focus value and the third IR focus value; and wherein the visible light pre-peak slope is determined based on the first IR focus value and the third IR focus value; move the lens to a fourth lens position; determine a fourth visible light focus value at the fourth lens position; determine a fourth IR focus value at the fourth lens position; and determine that the fourth visible light focus value exceeds the fourth IR focus value, wherein the IR post-peak slope is determined based on the second IR focus value and the fourth IR focus value; and wherein the visible light post-peak slope is determined based on the second IR focus value and the fourth IR focus value.

Aspect 11: The apparatus of claim 10, wherein the at least one processor is further configured to: determine a lens position range based on an intersection of the IR pre-peak slope and IR post peak slope and an intersection of the visible light pre-peak slope and visible light post-peak slope; and estimate the focused lens position based on the determined lens position range, wherein the focused lens position is further determined based on the estimated focus lens position.

Aspect 12: The apparatus of claim 1, wherein the threshold focus value comprises a percentage of a range of normalized focus values.

Aspect 13: The apparatus of claim 1, wherein the at least one processor is further configured to perform a fine focus search based on the output focused lens position.

Aspect 14: The apparatus of claim 1, further comprising the lens.

Aspect 15: A method for determining one or more lens positions, comprising: moving a lens to a first lens position; determining a first visible light focus value for a first image captured at the first lens position; determining a first infrared (IR) focus value for the first image captured at the first lens position; determining whether the first IR focus value exceeds the first visible light focus value; moving the lens to a second position based on whether the first IR focus value exceeds the first visible light focus value; determining a second visible light focus value for a second image captured at the second position; determining a second IR focus value for a second image captured at the second position; determining a focused lens position based on a comparison between the second visible light focus value and the second IR focus value and a threshold focus value; and outputting the focused lens position.

Aspect 16: The method of claim 15, wherein the first visible light focus value, the second visible light focus value, the first IR focus value, and the second IR focus value are normalized to a same range of normalized focus values.

Aspect 17: The method of claim 15, wherein comparing the second visible light focus value, the second IR focus value, and the threshold focus value comprises: determining a difference between the second IR focus value and the second visible light focus value; and comparing the difference to the threshold focus value.

Aspect 18: The method of claim 17, wherein determining the focused lens position comprises, based on a determination that the difference exceeds the threshold focus value, iteratively: moving the lens to a third position based on whether the second IR focus value exceeds the second visible light focus value; determining the second visible light focus value for an additional image captured at the third position; determining the second IR focus value for the additional image captured at the third position; determining the difference between the second IR focus value and the second visible light focus value; and stop iterating when the difference between the second IR focus value and the second visible light focus value is within the threshold focus value.

Aspect 19: The method of claim 15, wherein movement of the lens based on one or more IR focus values and one or more visible light focus values is performed based on a binary search pattern.

Aspect 20: The method of claim 15, wherein the first lens position is in a middle of a range of lens positions.

Aspect 21: The method of claim 15, further comprising determining a direction to move the lens based on whether the first IR focus value exceeds the second visible light focus value.

Aspect 22: The method of claim 21, wherein the second position is based on the determined direction to move the lens.

Aspect 23: The method of claim 15, further comprising: determining that the first IR focus value exceeds the first visible light focus value; determining a visible light pre-peak slope based on the first visible light focus value; determining a IR pre-peak slope based on the first IR focus value; determining that the second visible light focus value exceeds the second IR focus value; determining a visible light post-peak slope based on the second visible light focus value; and determining a IR post-peak slope based on the second IR focus value.

Aspect 24: The method of claim 23, further comprising: moving the lens to a third lens position; determining a third visible light focus value at the third lens position; determining a third IR focus value at the third lens position; determining that the third IR focus value exceeds the third visible light focus value, wherein the IR pre-peak slope is determined based on the first IR focus value and the third IR focus value; and wherein the visible light pre-peak slope is determined based on the first IR focus value and the third IR focus value; moving the lens to a fourth lens position; determining a fourth visible light focus value at the fourth lens position; determining a fourth IR focus value at the fourth lens position; and determining that the fourth visible light focus value exceeds the fourth IR focus value, wherein the IR post-peak slope is determined based on the second IR focus value and the fourth IR focus value; and wherein the visible light post-peak slope is determined based on the second IR focus value and the fourth IR focus value.

Aspect 25: The method of claim 24, further comprising: determining a lens position range based on an intersection of the IR pre-peak slope and IR post peak slope and an intersection of the visible light pre-peak slope and visible light post-peak slope; and estimating the focused lens position based on the determined lens position range, wherein the focused lens position is further determined based on the estimated focus lens position.

Aspect 26: The method of claim 15, wherein the threshold focus value comprises a percentage of a range of normalized focus values.

Aspect 27: The method of claim 15, further comprising performing a fine focus search based on the output focused lens position.

Aspect 28: A non-transitory computer-readable medium having stored thereon instructions that, when executed by at least one processor, cause the at least one processor to: move a lens to a first lens position; determine a first visible light focus value for a first image captured at the first lens position; determine a first infrared (IR) focus value for the first image captured at the first lens position; determine whether the first IR focus value exceeds the first visible light focus value; move the lens to a second position based on whether the first IR focus value exceeds the first visible light focus value; determine a second visible light focus value for a second image captured at the second position; determine a second IR focus value for a second image captured at the second position; determine a focused lens position based on a comparison between the second visible light focus value and the second IR focus value and a threshold focus value; and output the focused lens position.

Aspect 29: The non-transitory computer-readable medium of claim 28, wherein the first visible light focus value, the second visible light focus value, the first IR focus value, and the second IR focus value are normalized to a same range of normalized focus values.

Aspect 30: The non-transitory computer-readable medium of claim 28, wherein, to compare the second visible light focus value, the second IR focus value, and the threshold focus value, the instructions further cause the at least one processor to: determine a difference between the second IR focus value and the second visible light focus value; and compare the difference to the threshold focus value.

Aspect 31: An apparatus comprising means for performing any of the operations of aspects 15 to 27.

What is claimed is:

1. An apparatus for determining one or more lens positions, comprising:
at least one memory; and
at least one processor coupled to the at least one memory, the at least one processor configured to:
move a lens to a first lens position;
determine a first visible light focus value for a first image captured at the first lens position;
determine a first infrared (IR) focus value for the first image captured at the first lens position;
determine whether the first IR focus value exceeds the first visible light focus value;
move the lens to a second position based on whether the first IR focus value exceeds the first visible light focus value;
determine a second visible light focus value for a second image captured at the second position;
determine a second IR focus value for a second image captured at the second position;
determine a focused lens position based on a comparison between the second visible light focus value and the second IR focus value and a threshold focus value; and
output the focused lens position.

2. The apparatus of claim 1, wherein the first visible light focus value, the second visible light focus value, the first IR focus value, and the second IR focus value are normalized to a same range of normalized focus values.

3. The apparatus of claim 1, wherein, to compare the second visible light focus value, the second IR focus value, and the threshold focus value, the at least one processor is further configured to:
determine a difference between the second IR focus value and the second visible light focus value; and
compare the difference to the threshold focus value.

4. The apparatus of claim 3, wherein, to determine the focused lens position, the at least one processor is configured to, based on a determination that the difference exceeds the threshold focus value, iteratively:
move the lens to a third position based on whether the second IR focus value exceeds the second visible light focus value;
determine the second visible light focus value for an additional image captured at the third position;
determine the second IR focus value for the additional image captured at the third position;
determine the difference between the second IR focus value and the second visible light focus value; and
stop repeating when the difference between the second IR focus value and the second visible light focus value is within the threshold focus value.

5. The apparatus of claim 1, wherein the at least one processor is configured to move the lens based on one or more IR focus values and one or more visible light focus values using a binary search pattern.

6. The apparatus of claim 1, wherein the first lens position is in a middle of a range of lens positions.

7. The apparatus of claim 1, wherein the at least one processor is configured to determine a direction to move the lens based on whether the first IR focus value exceeds the first visible light focus value.

8. The apparatus of claim 7, wherein the second position is based on the determined direction to move the lens.

9. The apparatus of claim 1, wherein the at least one processor is further configured to:
determine that the first IR focus value exceeds the first visible light focus value;
determine a visible light pre-peak slope based on the first visible light focus value;
determine a IR pre-peak slope based on the first IR focus value;
determine that the second visible light focus value exceeds the second IR focus value;
determine a visible light post-peak slope based on the second visible light focus value; and
determine a IR post-peak slope based on the second IR focus value.

10. The apparatus of claim 9, wherein the at least one processor is further configured to:
move the lens to a third lens position;
determine a third visible light focus value at the third lens position;
determine a third IR focus value at the third lens position;
determine that the third IR focus value exceeds the third visible light focus value, wherein the IR pre-peak slope is determined based on the first IR focus value and the third IR focus value; and wherein the visible light pre-peak slope is determined based on the first IR focus value and the third IR focus value;
move the lens to a fourth lens position;
determine a fourth visible light focus value at the fourth lens position;
determine a fourth IR focus value at the fourth lens position; and
determine that the fourth visible light focus value exceeds the fourth IR focus value, wherein the IR post-peak slope is determined based on the second IR focus value and the fourth IR focus value; and wherein the visible light post-peak slope is determined based on the second IR focus value and the fourth IR focus value.

11. The apparatus of claim 10, wherein the at least one processor is further configured to:
determine a lens position range based on an intersection of the IR pre-peak slope and IR post peak slope and an intersection of the visible light pre-peak slope and visible light post-peak slope; and
estimate the focused lens position based on the determined lens position range, wherein the focused lens position is further determined based on the estimated focus lens position.

12. The apparatus of claim 1, wherein the threshold focus value comprises a percentage of a range of normalized focus values.

13. The apparatus of claim 1, wherein the at least one processor is further configured to perform a fine focus search based on the output focused lens position.

14. The apparatus of claim 1, further comprising the lens.

15. A method for determining one or more lens positions, comprising:
moving a lens to a first lens position;
determining a first visible light focus value for a first image captured at the first lens position;
determining a first infrared (IR) focus value for the first image captured at the first lens position;
determining whether the first IR focus value exceeds the first visible light focus value;
moving the lens to a second position based on whether the first IR focus value exceeds the first visible light focus value;
determining a second visible light focus value for a second image captured at the second position;
determining a second IR focus value for a second image captured at the second position;
determining a focused lens position based on a comparison between the second visible light focus value and the second IR focus value and a threshold focus value; and
outputting the focused lens position.

16. The method of claim 15, wherein the first visible light focus value, the second visible light focus value, the first IR focus value, and the second IR focus value are normalized to a same range of normalized focus values.

17. The method of claim 15, wherein comparing the second visible light focus value, the second IR focus value, and the threshold focus value comprises:
determining a difference between the second IR focus value and the second visible light focus value; and
comparing the difference to the threshold focus value.

18. The method of claim 17, wherein determining the focused lens position comprises, based on a determination that the difference exceeds the threshold focus value, iteratively:
moving the lens to a third position based on whether the second IR focus value exceeds the second visible light focus value;
determining the second visible light focus value for an additional image captured at the third position;
determining the second IR focus value for the additional image captured at the third position;
determining the difference between the second IR focus value and the second visible light focus value; and
stop iterating when the difference between the second IR focus value and the second visible light focus value is within the threshold focus value.

19. The method of claim 15, wherein movement of the lens based on one or more IR focus values and one or more visible light focus values is performed based on a binary search pattern.

20. The method of claim 15, wherein the first lens position is in a middle of a range of lens positions.

21. The method of claim 15, further comprising determining a direction to move the lens based on whether the first IR focus value exceeds the second visible light focus value.

22. The method of claim 21, wherein the second position is based on the determined direction to move the lens.

23. The method of claim 15, further comprising:
determining that the first IR focus value exceeds the first visible light focus value;
determining a visible light pre-peak slope based on the first visible light focus value;
determining a IR pre-peak slope based on the first IR focus value;
determining that the second visible light focus value exceeds the second IR focus value;
determining a visible light post-peak slope based on the second visible light focus value; and
determining a IR post-peak slope based on the second IR focus value.

24. The method of claim 23, further comprising:
moving the lens to a third lens position;
determining a third visible light focus value at the third lens position;
determining a third IR focus value at the third lens position;
determining that the third IR focus value exceeds the third visible light focus value, wherein the IR pre-peak slope is determined based on the first IR focus value and the third IR focus value; and wherein the visible light pre-peak slope is determined based on the first IR focus value and the third IR focus value;
moving the lens to a fourth lens position;
determining a fourth visible light focus value at the fourth lens position;
determining a fourth IR focus value at the fourth lens position; and
determining that the fourth visible light focus value exceeds the fourth IR focus value, wherein the IR post-peak slope is determined based on the second IR focus value and the fourth IR focus value; and wherein the visible light post-peak slope is determined based on the second IR focus value and the fourth IR focus value.

25. The method of claim 24, further comprising:
determining a lens position range based on an intersection of the IR pre-peak slope and IR post peak slope and an intersection of the visible light pre-peak slope and visible light post-peak slope; and
estimating the focused lens position based on the determined lens position range, wherein the focused lens position is further determined based on the estimated focus lens position.

26. The method of claim 15, wherein the threshold focus value comprises a percentage of a range of normalized focus values.

27. The method of claim 15, further comprising performing a fine focus search based on the output focused lens position.

28. A non-transitory computer-readable medium having stored thereon instructions that, when executed by at least one processor, cause the at least one processor to:
move a lens to a first lens position;
determine a first visible light focus value for a first image captured at the first lens position;
determine a first infrared (IR) focus value for the first image captured at the first lens position;
determine whether the first IR focus value exceeds the first visible light focus value;
move the lens to a second position based on whether the first IR focus value exceeds the first visible light focus value;
determine a second visible light focus value for a second image captured at the second position;
determine a second IR focus value for a second image captured at the second position;
determine a focused lens position based on a comparison between the second visible light focus value and the second IR focus value and a threshold focus value; and
output the focused lens position.

29. The non-transitory computer-readable medium of claim 28, wherein the first visible light focus value, the second visible light focus value, the first IR focus value, and the second IR focus value are normalized to a same range of normalized focus values.

30. The non-transitory computer-readable medium of claim 28, wherein, to compare the second visible light focus value, the second IR focus value, and the threshold focus value, the instructions further cause the at least one processor to:
determine a difference between the second IR focus value and the second visible light focus value; and
compare the difference to the threshold focus value.
